(19) United States
(12) Patent Application Publication
(10) Pub. No.: US 2026/0084910 A1
(43) Pub. Date: Mar. 26, 2026

(54) SHEET STORAGE DEVICE AND IMAGE FORMING APPARATUS

(71) Applicant: FUJIFILM Business Innovation Corp., Tokyo (JP)

(72) Inventors: Shuhei KOBORI, Kanagawa (JP); Shinji YAGINUMA, Kanagawa (JP); Yuya OKAWA, Kanagawa (JP)

(73) Assignee: FUJIFILM Business Innovation Corp., Tokyo (JP)

(21) Appl. No.: 19/025,181

(22) Filed: Jan. 16, 2025

(30) Foreign Application Priority Data
Sep. 25, 2024 (JP) 2024-165868

(51) Int. Cl. B65H 1/08; B65H 3/06; G03G 15/00

(52) U.S. Cl. CPC B65H 1/08; B65H 3/06; G03G 15/6511; G03G 15/6529; B65H 2801/06; G03G 2215/004

(57) ABSTRACT

A sheet storage device includes: a sheet storage body that stores sheets and that is capable of being pulled out of and pushed into an apparatus body; a transport roller pair provided in the apparatus body to separate and transport the sheets stored in the sheet storage body, one sheet at a time; and a press-contact unit that abuts against the sheet storage body mounted to the apparatus body to move one of transport rollers of the transport roller pair from a press-contact cancellation position to a press-contact position, in which the press-contact unit abuts against the sheet storage body earlier than a different abutment unit that abuts against the sheet storage body when mounting the sheet storage body to the apparatus body.

### Cross-Reference to Related Application

This application is based on and claims priority under 35 USC 119 from Japanese Patent Application No. 2024-165868 filed September 25, 2024.

### Background

### i Technical Field

The present disclosure relates to a sheet storage device and an image forming apparatus.

### ii Related Art

There have hitherto been proposed techniques related to sheet storage devices, such as those disclosed in Japanese Unexamined Patent Application Publication No. 2014-156324, Japanese Unexamined Patent Application Publication No. 2020-193090, etc., for example.

In Japanese Unexamined Patent Application Publication No. 2014-156324, a first load position at which a first load for engagement of a sheet tray with a lock portion becomes maximum and a second load position at which a second load for sliding of a release lever from a first position to a second position becomes maximum are disposed differently from each other in a path for movement of the sheet tray from an extracted position to a feed position.

In Japanese Unexamined Patent Application Publication No. 2020-193090, a sheet detection portion is provided above a second sheet storage portion, includes a sheet abutment member capable of abutting against sheets stored in the second sheet storage portion, and has an inclined surface directed from the upper side toward the lower side from the downstream side toward the upstream side in the direction of insertion of a first sheet storage portion, on at least one of the downstream side in the insertion direction on the lower side of the first sheet storage portion or the upstream side in the insertion direction on the upper side of the sheet abutment member.

### SUMMARY

Aspects of non-limiting embodiments of the present disclosure relate to reducing an operation force applied when mounting a sheet storage body to an apparatus body compared to when a press-contact unit abuts against the sheet storage body at the same time as a different press-contact unit.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a sheet storage device including: a sheet storage body that stores sheets and that is capable of being pulled out of and pushed into an apparatus body; a transport roller pair provided in the apparatus body to separate and transport the sheets stored in the sheet storage body, one sheet at a time; and a press-contact unit that abuts against the sheet storage body mounted to the apparatus body to move one of transport rollers of the transport roller pair from a press-contact cancellation position to a press-contact position, in which the press-contact unit abuts against the sheet storage body earlier than a different abutment unit that abuts against the sheet storage body when mounting the sheet storage body to the apparatus body.

### BRIEF DESCRIPTION OF THE DRAWINGS

An exemplary embodiment of the present disclosure will be described in detail based on the following figures, wherein:

FIG. 1 illustrates the overall configuration of an image forming apparatus integrating a sheet storage device according to a first exemplary embodiment of this disclosure;

FIG. 2 illustrates the configuration of an image forming unit of the image forming apparatus according to the first exemplary embodiment of this disclosure;

FIG. 3 is a perspective view illustrating the configuration of a paper feed tray;

FIG. 4 is a sectional view illustrating the configuration of a portion of the sheet storage device;

FIG. 5 is a perspective view illustrating the configuration of the paper feed tray in the state of being mounted to an apparatus body of the image forming apparatus;

FIG. 6 illustrates the configuration of a pull-in device;

FIG. 7 is a perspective view illustrating the configuration of the apparatus body of the image forming apparatus integrating the sheet storage device according to the first exemplary embodiment of this disclosure;

FIG. 8 is a perspective view illustrating the configuration of a paper feed portion of the sheet storage device according to the first exemplary embodiment of this disclosure;

FIG. 9 is a front view illustrating the configuration of a portion of the image forming apparatus integrating the sheet storage device according to the first exemplary embodiment of this disclosure;

FIGS. 10A to 10C each illustrate the configuration of a slide lever;

FIG. 11 is a front view illustrating the configuration of a holding member;

FIG. 12 is a front view illustrating the configuration of a portion of the image forming apparatus integrating the sheet storage device according to the first exemplary embodiment of this disclosure;

FIG. 13 is a plan view illustrating the configuration of the paper feed tray in the state of being mounted; and

FIG. 14 is a plan view illustrating the configuration of the paper feed tray in the state of being mounted.

### DETAILED DESCRIPTION

An embodiment of this disclosure will be described below with reference to the drawings.

### First Exemplary Embodiment

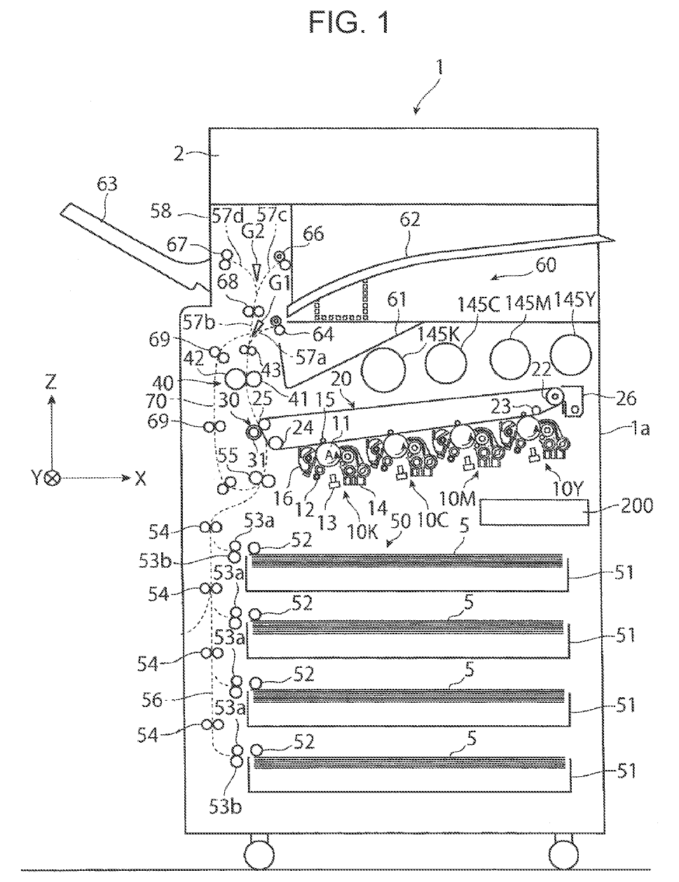

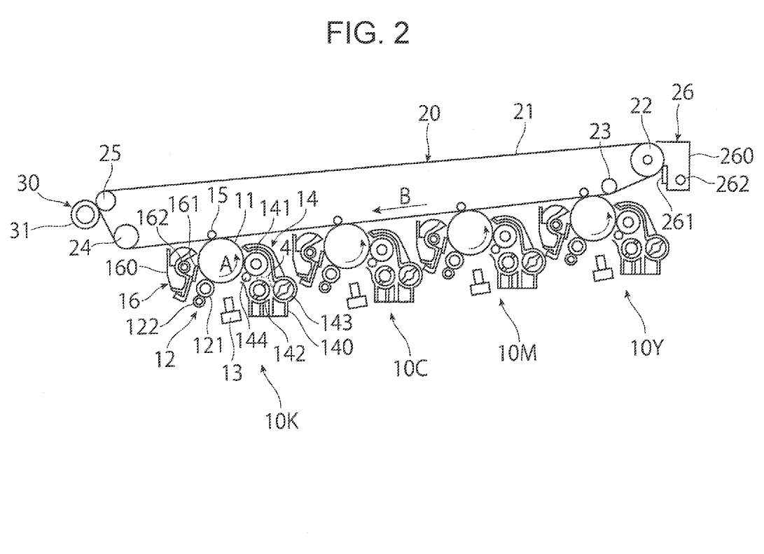

FIGS. 1 and 2 illustrate an image forming apparatus integrating a sheet storage device according to a first exemplary embodiment. FIG. 1 illustrates an overview of the image forming apparatus. FIG. 2 illustrates a portion (such as an imaging device) of the image forming apparatus as enlarged. In FIG. 1, symbol X denotes the horizontal direction (width direction) of the image forming apparatus, symbol Y denotes the depth direction of the image forming apparatus, and symbol Z denotes the vertical direction of the image forming apparatus.

### Overall Configuration of Image Forming Apparatus

An image forming apparatus 1 according to the first exemplary embodiment is constituted as a color copier, for example. The image forming apparatus 1 includes an image reading device 2 provided at the upper end of an apparatus body 1a to read an image of a document (not illustrated). The image forming apparatus 1 not only functions to copy the image of the document read by the image reading device 2, but also functions as a color printer, etc., that records image information sent from a host computer (not illustrated), etc.

The image forming apparatus 1 includes, inside the apparatus body 1a, a plurality of imaging devices 10, an intermediate transfer device 20, a sheet storage device 50 as an example of a sheet storage according to the first exemplary embodiment, a fixing device 40, etc. The plurality of imaging devices 10 form toner images to be developed using a toner that constitutes a developer. The intermediate transfer device 20 holds the toner images formed by the imaging devices 10, and transports the toner images finally to a second transfer position at which the toner images are transferred to recording paper 5, as an example of a sheet, through a second transfer. The sheet storage device 50 stores and feeds the recording paper 5 to be supplied to the second transfer position of the intermediate transfer device 20. The fixing device 40 fixes the toner images on the recording paper 5 transferred by the intermediate transfer device 20 through the second transfer. The plurality of imaging devices 10 and the intermediate transfer device 20 constitute an image former that forms an image on the recording paper 5. The apparatus body 1a of the image forming apparatus 1 is formed from a support structural member, an exterior cover, etc.

The imaging devices 10 are constituted from four imaging devices 10Y, 10M, 10C, and 10K that exclusively form toner images in four colors, namely yellow (Y), magenta (M), cyan (C), and black (K). The four imaging devices 10 (Y, M, C, K) are disposed in the internal space of the apparatus body 1a in one line in an inclined state.

As illustrated in FIGS. 1 and 2, the imaging devices 10 (Y, M, C, K) for yellow (Y), magenta (M), cyan (C), and black (K) each include a rotatable photoconductor drum 11 as an example of an image holding body that holds an electrostatic latent image. A charging device 12, an exposure device 13, a developing device 14, a first transfer device 15, a drum cleaning device 16, etc., are disposed around the photoconductor drum 11. The charging device 12 charges a peripheral surface (image holding surface) of the photoconductor drum 11, on which an image may be formed, to a prescribed potential. The exposure device 13 forms an electrostatic latent image for each color with a potential difference by irradiating the charged peripheral surface of the photoconductor drum 11 with light based on information (signal) on an image. The developing device 14 develops the electrostatic latent image using a toner of a developer for the corresponding color (Y, M, C, K) to form a toner image. The first transfer device 15 transfers each toner image to the intermediate transfer device 20. The drum cleaning device 16 cleans the photoconductor drum 11 by removing attached matter such as a residual toner adhering to the image holding surface of the photoconductor drum 11 after a first transfer.

As illustrated in FIG. 2, the developing device 14 (Y, M, C, K) is constituted by disposing a developing roller 141, agitation-transport members 142, 143, a layer thickness regulation member 144, etc., inside a housing 140. The housing 140 has an opening and a storage chamber for a developer. The developing roller 141 holds and transports the developer to a developing region that faces the photoconductor drum 11. The agitation-transport members 142, 143 are each a screw auger, etc., that transports the developer so as to pass through the developing roller 141 while agitating the developer. The layer thickness regulation member 144 regulates the amount (layer thickness) of the developer held by the developing roller 141. The developer (Y, M, C, K) for the four colors may be a two-part developer containing a non-magnetic toner and a magnetic carrier.

The first transfer device 15 is a contact-type transfer device that includes a first transfer roller that rotates in contact with the peripheral surface of the photoconductor drum 11 via an intermediate transfer belt 21 at a first transfer position and that is supplied with a first transfer voltage.

The drum cleaning device 16 is composed of a cleaning blade 161, a feeding member 162, etc., disposed inside a body 160 in a container shape. The cleaning blade 161 cleans the drum by removing attached matter such as a residual toner. The feeding member 162 recovers the attached matter such as the toner removed by the cleaning blade 161, and transports and feeds the attached matter to a recovery system (not illustrated).

As illustrated in FIG. 1, the intermediate transfer device 20 is disposed at a position above the imaging devices 10 (Y, M, C, K) along the vertical direction Z. The intermediate transfer device 20 is principally composed of the intermediate transfer belt 21, a plurality of belt support rollers 22 to 25, a second transfer device 30, and a belt cleaning device 26. As illustrated in FIG. 2, the intermediate transfer belt 21 rotates in the direction indicated by the arrow B while passing through the first transfer position between the photoconductor drum 11 and the first transfer device 15 (first transfer roller). The plurality of belt support rollers 22 to 25 rotatably support the intermediate transfer belt 21 by holding the intermediate transfer belt 21 in a desired state from the inner surface. The second transfer device 30 is disposed on the outer peripheral surface (image holding surface) side of the intermediate transfer belt 21 supported by the belt support roller 25 to transfer the toner images on the intermediate transfer belt 21 to the recording paper 5 through a second transfer. The drum cleaning device 26 cleans the intermediate transfer belt 21 by removing the attached matter such as a residual toner and paper dust attached to the outer peripheral surface of the intermediate transfer belt 21 after passing through the second transfer device 30.

The belt support roller 22 is constituted as a drive roller rotationally driven by a drive device (not illustrated). The belt support roller 23 is constituted as a surface forming roller that holds the travel position of the intermediate transfer belt 21. The belt support roller 24 is constituted as a facing roller that faces a sensor (not illustrated). The belt support roller 25 is constituted as a back-up roller for the second transfer device 30.

The second transfer device 30 is a contact-type transfer device that includes a second transfer roller 31. The second transfer roller 31 rotates in contact with the peripheral surface of the intermediate transfer belt 21 at the second transfer position. A direct-current voltage that exhibits a polarity opposite to or the same polarity as the charging polarity of the toner is supplied as the second transfer voltage to the second transfer roller 31 or the belt support roller 25 of the intermediate transfer device 20.

As illustrated in FIG. 2, the belt cleaning device 26 includes a body 260, a cleaning plate 261, a feeding member 262, etc. The body 260 is formed in the shape of a partially open container. The cleaning plate 261 is disposed in contact with the peripheral surface of the intermediate transfer belt 21 after a second transfer with a prescribed pressure to clean the intermediate transfer belt 21 by removing attached matter such as a residual toner. The feeding member 262 is constituted from a screw auger, etc., that recovers the attached matter such as the toner removed by the cleaning plate 261 and that transports and feeds the attached matter to a recovery system (not illustrated).

As illustrated in FIG. 1, the fixing device 40 is constituted by disposing a heating rotary body 41, a pressurizing rotary body 42, etc. The heating rotary body 41 is formed in the form of a roller or a belt to be heated by a heating unit such that the surface temperature is kept at a prescribed temperature. The pressurizing rotary body 42 is formed in the form of a roller or a belt to rotate in contact with the heating rotary body 41 with a prescribed pressure substantially along the axial direction of the heating rotary body 41. An exit roller 43 that transports the recording paper 5 which has been subjected to a fixing process is provided at an exit portion of the fixing device 40. In the fixing device 40, a contact portion at which the heating rotary body 41 and the pressurizing rotary body 42 contact each other serves as a fixing processing portion at which a prescribed fixing process (heating and pressurizing) is performed.

The sheet storage device 50 is disposed at a position under the imaging devices 10 (Y, M, C, K) for yellow (Y), magenta (M), cyan (C), and black (K) along the vertical direction Z. The sheet storage device 50 is principally composed of one or more paper feed trays 51 as an example sheet storage body, a nudger roller 52, and a feed roller 53a and a retard roller 53b as an example of a transport roller pair. The paper feed tray 51 stores the recording paper 5 of a desired size, type, etc., in a stacked state. The nudger roller 52 feeds the recording paper 5 from the paper feed tray 51. The feed roller 53a and the retard roller 53b separate and feed the recording paper 5 fed by the nudger roller 52, one sheet at a time. The paper feed tray 51 is attached such that the paper feed tray 51 may be pulled out toward the side of the front surface (a surface that a user faces during operation) of the apparatus body 1a, or toward the front side of the drawing sheet surface in the illustrated example, for example. The sheet storage device 50 will be discussed in detail later.

A paper feeding transport path 56, through which the recording paper 5 fed from the sheet storage device 50 is transported to the second transfer position, is provided between the sheet storage device 50 and the second transfer device 30, the paper feeding transport path 56 being composed of one or more paper transport roller pairs 54, 55, a transport guide (not illustrated), etc. The paper transport roller pair 55 is constituted as registration rollers that adjust the transport timing of the recording paper 5, for example. A paper ejection transport portion 58 is provided above the fixing device 40 along the vertical direction Z. The paper ejection transport portion 58 ejects the recording paper 5 after fixation fed from the exit roller 43 of the fixing device 40 to a sheet ejection device 60. The sheet ejection device 60 is disposed at the upper portion of the apparatus body 1a. The paper ejection transport portion 58 includes first to fourth paper ejection transport paths 57a to 57d.

The sheet ejection device 60 includes first and second ejection trays 61, 62 and a third ejection tray 63. The first and second ejection trays 61, 62 are of a so-called in-body ejection type provided at the upper portion of the apparatus body 1a. The third ejection tray 63 is provided on a side surface (left side surface in the drawing) of the paper ejection transport portion 58 to be directed to the outside. The first paper ejection transport path 57a, the third paper ejection transport path 57c, and the fourth paper ejection transport path 57d are provided inside the paper ejection transport portion 58. The first paper ejection transport path 57a includes a first paper ejection roller pair 64 that ejects the recording paper 5 to the first ejection tray 61 as branched from the second paper ejection transport path 57b. The third paper ejection transport path 57c includes a second paper ejection roller pair 66 that ejects the recording paper 5 to the second ejection tray 62 as branched from the second paper ejection transport path 57b. The fourth paper ejection transport path 57d includes a third paper ejection roller pair 67 that ejects the recording paper 5 to the third ejection tray 63 as branched from the third paper ejection transport path 57c.

In FIG. 1, reference sign 68 denotes a paper transport roller pair provided in the middle of the second paper ejection transport path 57b. Reference sign G1 denotes a first switching gate that branches the first paper ejection transport path 57a and the second paper ejection transport path 57b. Reference sign G2 denotes a second switching gate that branches the third paper ejection transport path 57c and the fourth paper ejection transport path 57d.

As illustrated in FIG. 1, a double-sided printing transport path 70 is provided inside the apparatus body 1a. The double-sided printing transport path 70 switches the rotational direction of the first paper ejection roller pair 64 from the forward direction to the reverse direction while the first paper ejection roller pair 64 is holding the recording paper 5 on one side of which an image has been formed. The double-sided printing transport path 70 includes a paper transport roller pair 69 that transports the recording paper 5 with the front and back sides reversed to the paper transport roller pair 55 again.

In FIG. 1, reference sign 145 (Y, M, C, K) denotes a toner cartridge that stores a developer containing at least a toner to be supplied to the corresponding developing device 14 (Y, M, C, K). A plurality of toner cartridges 145 are arranged along a direction perpendicular to the drawing sheet surface.

In FIG. 1, reference sign 200 denotes a control device that integrally controls operation of the image forming apparatus 1. The control device 200 includes a central processing unit (CPU), a read only memory (ROM), a random access memory (RAM), a bus that connects the CPU, the ROM, etc., a communication interface, etc. (not illustrated).

### Basic Operation of Image Forming Apparatus

Basic image forming operation by the image forming apparatus 1 will be described below.

Here, operation to form a full-color image constituted by combining toner images in four colors (Y, M, C, K) using the four imaging devices 10 (Y, M, C, K) will be described.

When the control device 200 of the image forming apparatus 1 receives instruction information that requests image forming operation (printing), the four imaging devices 10 (Y, C, M, K), the intermediate transfer device 20, the second transfer device 30, the fixing device 40, etc. are started.

In each of the imaging devices 10 (Y, M, C, K), first, the photoconductor drum 11 is rotated in the direction indicated by the arrow A. The charging device 12 charges the surface of the photoconductor drum 11 to a prescribed polarity and potential. Subsequently, the exposure device 13 irradiates the surface of the photoconductor drum 11 after being charged with light emitted on the basis of an image signal obtained by converting image information input to the image forming apparatus 1 into color components (Y, M, C, K). As a result, an electrostatic latent image for each color component with a prescribed potential difference is formed on the surface of the photoconductor drum 11.

Subsequently, each of the developing devices 14 (Y, M, C, K) develops the electrostatic latent image for each color component formed on the photoconductor drum 11 by supplying a toner for the corresponding color (Y, M, C, K) charged to the prescribed polarity (negative polarity) from the developing roller 141 to the electrostatic latent image and causing the toner to electrostatically adhere to the electrostatic latent image. As a result of this development, the electrostatic latent images for the color components formed on the photoconductor drums 11 are rendered visible as toner images in the four colors (Y, M, C, K) developed using toners for the corresponding colors.

Subsequently, the toner images in the respective colors formed on the photoconductor drums 11 of the imaging devices 10 (Y, M, C, K) are transported to the first transfer position. Then, the first transfer devices 15 perform a first transfer in which the toner images in the respective colors are sequentially superposed on the intermediate transfer belt 21 which rotates in the direction indicated by the arrow B.

In each of the imaging devices 10 (Y, M, C, K) in which a first transfer has been finished, the drum cleaning device 16 cleans the surface of the photoconductor drum 11 by scraping off the attached matter. Consequently, the imaging devices 10 (Y, M, C, K) are rendered ready for the next imaging operation.

Subsequently, in the intermediate transfer device 20, the toner images that have been subjected to a first transfer are held and transported to the second transfer position through rotation of the intermediate transfer belt 21. In the sheet storage device 50, on the other hand, the prescribed recording paper 5 is fed to the paper feeding transport path 56 in accordance with the imaging operation. In the paper feeding transport path 56, the paper transport roller pair 55 as registration rollers feeds and supplies the recording paper 5 to the second transfer position in accordance with the transfer timing.

At the second transfer position, the second transfer roller 31 of the second transfer device 30 performs a second transfer in which the toner images on the intermediate transfer belt 21 are collectively transferred to the recording paper 5. In the intermediate transfer device 20 in which a second transfer has been finished, the belt cleaning device 26 cleans the intermediate transfer belt 21 by removing attached matter such as a residual toner on the surface of the intermediate transfer belt 21 after a second transfer.

Subsequently, the recording paper 5 to which the toner images have been transferred through a second transfer is released from the intermediate transfer belt 21 and the second transfer roller 31, and thereafter transported to the fixing device 40. In the fixing device 40, the recording paper 5 after the second transfer is introduced to a contact portion between the heating rotary body 41 and the pressurizing rotary body 42 rotating, and caused to pass through the contact portion. In this way, unfixed toner images are fixed to the recording paper 5 by performing a necessary fixing process (heating and pressurizing). Finally, the recording paper 5 after the fixation is ejected to any of the first to third ejection trays 61 to 63 installed at the upper portion of the apparatus body 1a via the first to fourth paper ejection transport paths 57a to 57d in image forming operation in which an image is to be formed on only one side of the recording paper 5.

When an image is to be formed on both sides of the recording paper 5, the recording paper 5 on one side of which an image has been formed is not ejected to the first ejection tray 61 by the first paper ejection roller pair 64. The rotational direction of the first paper ejection roller pair 64 is switched to the reverse direction while the first paper ejection roller pair 64 is holding the rear end of the recording paper 5. The recording paper 5 transported in the opposite direction by the first paper ejection roller pair 64 is transported to the double-sided printing transport path 70 including the paper transport roller pair 69, etc., and transported to the paper transport roller pair 55 again with the front and back sides reversed. The paper transport roller pair 55 feeds and supplies the recording paper 5 to the second transfer position in accordance with the transfer timing, and forms an image on the back side of the recording paper 5. Subsequently, the recording paper 5 on the back side of which an image has been fixed is ejected to any of the first to third ejection trays 61 to 63 installed at the upper portion of the apparatus body 1a via any of the first to fourth paper ejection transport paths 57a to 57d.

Through the above operation, the recording paper 5 on one side or both sides of which a full-color image constituted by combining toner images in four colors has been formed is output.

### Configuration of Sheet Storage Device

As illustrated in FIG. 1, the image forming apparatus 1 includes the sheet storage device 50. The apparatus body 1a of the image forming apparatus 1 also serves as an apparatus body of the sheet storage device 50. The sheet storage device 50 is principally composed of the plurality of (four in the illustrated example) paper feed trays 51, the nudger roller 52, the feed roller 53a, and the retard roller 53b. The paper feed tray 51 stores the recording paper 5 of a desired size, type, etc., in a stacked state. The nudger roller 52, the feed roller 53a, and the retard roller 53b feed the recording paper 5, one sheet at a time, from the paper feed tray 51.

As discussed above, the paper feed tray 51 is attached such that the paper feed tray 51 may be pulled out toward the side of the front surface (a surface that a user faces during operation) of the apparatus body 1a, or toward the front side of the drawing sheet surface in the illustrated example, for example.

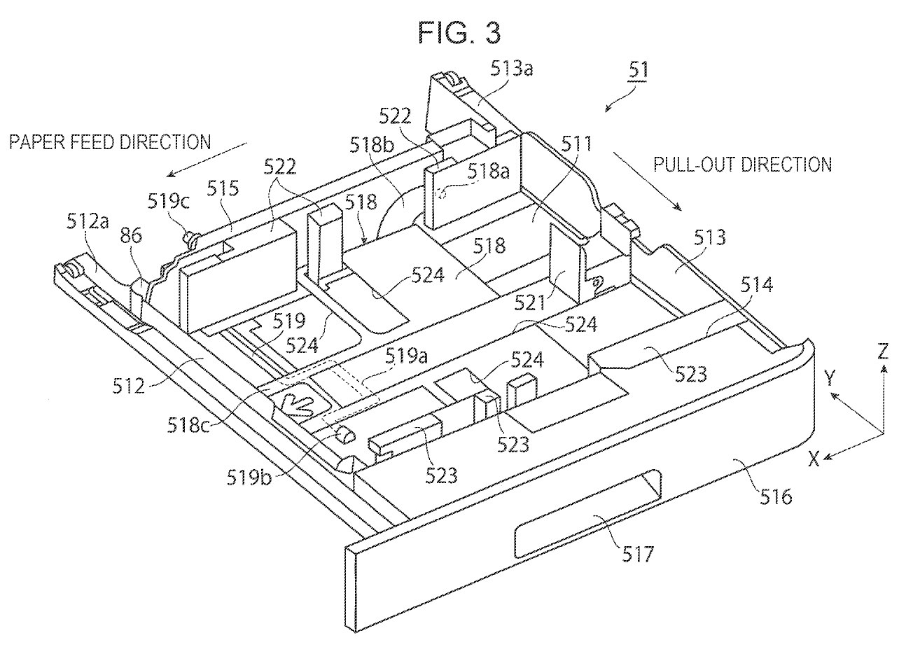

As illustrated in FIG. 3, the paper feed tray 51 is constituted as a box body substantially in the shape of a rectangular parallelepiped that has a height matching the number of sheets of the recording paper 5 to be stored inside the paper feed tray 51 and has a fully open upper end surface. The paper feed tray 51 includes a bottom wall portion 511, left and right side wall portions 512, 513, and front and rear wall portions 514, 515. The bottom wall portion 511 is formed in a generally rectangular shape in plan. The left and right side wall portions 512, 513 are disposed on the left and right sides of the bottom wall portion 511 along the horizontal direction X. In the left and right side wall portions 512, 513, end portions 512a, 513a on the back surface side along the depth direction Y are disposed to project toward the back surface side with respect to the rear wall portion 515. The front and rear wall portions 514, 515 are disposed on the front and rear sides of the bottom wall portion 511 along the depth direction Y. The front surface of the paper feed tray 51 is formed as an operation panel 516. The operation panel 516 constitutes the exterior shape of the front surface of the apparatus body 1a together with a front panel (not illustrated) of the apparatus body 1a. The operation panel 516 of the paper feed tray 51 is provided with a grip portion 517 to be gripped by a hand when the user pulls the paper feed tray 51 out of the apparatus body 1a and pushes the paper feed tray 51 into the apparatus body 1a.

The apparatus body 1a is provided with a detector (not illustrated) that detects that the paper feed tray 51 is pulled out when the user puts his/her hand on the grip portion 517 of the operation panel 516 and pulls the paper feed tray 51 out of the apparatus body 1a. A size detector 520b that detects the size of the recording paper 5 to be discussed later may also serve as the detector.

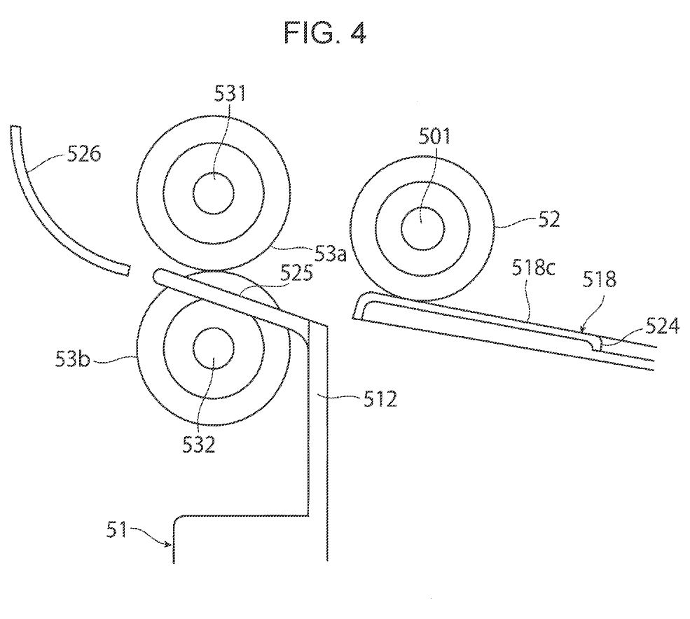

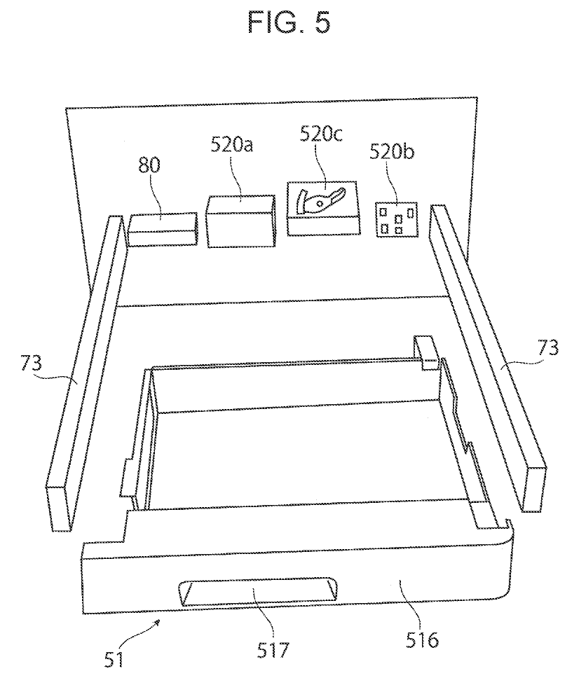

A bottom plate 518 on which a plurality of sheets of the recording paper 5 are placed in a stacked state is disposed at the bottom wall portion 511 of the paper feed tray 51. The bottom plate 518 is attached to the front and rear wall portions 514, 515 of the paper feed tray 51 so as to be turnable about a turning fulcrum 518a. The turning fulcrum 518a is provided on an arm member 518b provided at both front and rear end portions of the bottom plate 518 along the depth direction Y. As a result, an end portion 518c of the bottom plate 518 on the downstream side along the paper feed direction is turnable upward, as illustrated in FIG. 4. As illustrated in FIG. 3, a driving member 519 is rotatably disposed on the back surface of the end portion 518c of the bottom plate 518 on the downstream side along the paper feed direction. As partially indicated by the broken line in FIG. 3, an intermediate portion 519a of the driving member 519 is formed in a crank shape. The distal end of the driving member 519 is rotatably attached to the bottom wall portion 511 of the paper feed tray 51 via a journal portion 519b. The rear wall portion 515 of the paper feed tray 51 is provided with a coupling member 519c that receives transmission of a driving force from the apparatus body 1a. As illustrated in FIG. 5, when the paper feed tray 51 is mounted at a paper feed position of the apparatus body 1a, the driving member 519 receives a driving force transmitted via the coupling member 519c from a driver 520a as an example of a different abutment unit (driving force transmission unit) provided on the apparatus body 1a, and is rotationally driven by a prescribed angle in a prescribed direction.

When the paper feed tray 51 is pulled out of the apparatus body 1a, the bottom plate 518 is separated from the driver 520a on the apparatus body 1a side and descends to the bottom wall portion 511 due to its own weight. In FIG. 3, the bottom plate 518 is illustrated in the state of being descended to the bottom wall portion 511.

When the detector (not illustrated) detects that the paper feed tray 51 is mounted at the paper feed position of the apparatus body 1a, on the other hand, the bottom plate 518 moves upward with the driving member 519 driven via the coupling member 519c by the driver 520a on the apparatus body 1a side. Then, the bottom plate 518 stops at the paper feed position at which the uppermost sheet of the recording paper 5, among the sheets of the recording paper 5 stored in the paper feed tray 51, abuts against the nudger roller 52.

As illustrated in FIG. 3, an end guide 521 and side guides 522, 523 are disposed on the bottom wall portion 511 of the paper feed tray 51. The end guide 521 positions the recording paper 5 stored inside the paper feed tray 51 in abutment with an end portion of the recording paper 5 on the upstream side along the paper feed direction. The side guides 522, 523 position the recording paper 5 in abutment with both end portions of the recording paper 5 along the width direction intersecting the paper feed direction. The end guide 521 is attached to the bottom wall portion 511 of the paper feed tray 51 so as to be movable along the paper feed direction of the recording paper 5 and kept at a stopped position. The side guides 522, 523 are attached to the bottom wall portion 511 of the paper feed tray 51 so as to be movable along the width direction intersecting the paper feed direction of the recording paper 5 in conjunction with each other equidistantly from the center in the width direction intersecting the paper feed direction and kept at a stopped position. The paper feed tray 51 feeds the recording paper 5 using the center portion along the depth direction Y intersecting the paper feed direction as the reference (so-called "center registration"). A size identifier (not illustrated) that identifies the size of the recording paper 5 stored in the paper feed tray 51 in accordance with the positions of the end guide 521 and the side guides 522, 523 is disposed on the rear wall portion 515 of the paper feed tray 51 to face the rear side. The size identifier (not illustrated) of the paper feed tray 51 is detected by a size detector 520b as an example of the different abutment unit of the apparatus body 1a, as illustrated in FIG. 5.

The bottom plate 518 is provided with a plurality of openings 524 in a rectangular shape in plan that allow movement of the end guide 521 and the side guides 522, 523.

In the sheet storage device 50, as illustrated in FIG. 4, the nudger roller 52 is disposed at a position corresponding to an end portion of each paper feed tray 51 on the downstream side along the paper feed direction so as to be rotatable at a prescribed timing. The nudger roller 52 feeds the uppermost sheet of the recording paper 5, among the sheets of the recording paper 5 stacked on the bottom plate 518, in contact with the uppermost sheet of the recording paper 5.

In the sheet storage device 50, in addition, the feed roller 53a and the retard roller 53b are disposed on the downstream side of the nudger roller 52 along the paper feed direction. The feed roller 53a and the retard roller 53b are rotationally driven at a prescribed timing. The feed roller 53a is brought into press contact with the retard roller 53b to transport only the one uppermost sheet of the recording paper 5, among the sheets of the recording paper 5 to be fed by the nudger roller 52, toward the downstream side along the paper feed direction. On the other hand, the retard roller 53b is rotated in a direction opposite to the feed roller 53a or biased in the opposite direction, for example. The retard roller 53b transports the second and subsequent sheets of the recording paper 5, fed together with the uppermost sheet of the recording paper 5, in a direction opposite to the paper feed direction. The retard roller 53b operates such that a plurality of sheets of the recording paper 5 are not fed at the same time.

The nudger roller 52, the feed roller 53a, and the retard roller 53b are disposed slightly on the back surface side with respect to the center of each paper feed tray 51 along the width direction intersecting the paper feed direction of the recording paper 5.

As illustrated in FIG. 4, the left side wall portion 512 located at an end portion of the paper feed tray 51 on the downstream side along the paper feed direction is provided with an introduction plate 525 on the front surface side along the width direction intersecting the paper feed direction of the recording paper 5. The introduction plate 525 introduces the distal end of the recording paper 5 fed by the nudger roller 52 to a nip portion between the feed roller 53a and the retard roller 53b.

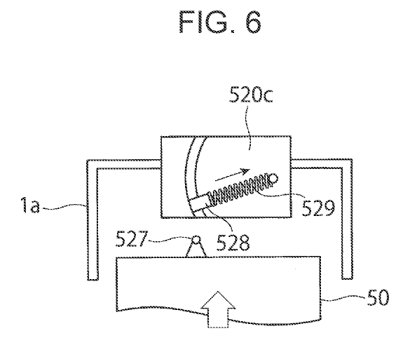

As illustrated in FIG. 5, a pull-in device 520c as an example of a pull-in unit that pulls the paper feed tray 51 to the paper feed position is disposed at an end portion of the apparatus body 1a on the back surface side. As illustrated in FIG. 6, the pull-in device 520c includes an engagement member 528 that engages with an engagement pin 527 provided at an end portion of the paper feed tray 51 on the back surface side. The pull-in device 520c pulls in the paper feed tray 51 to the paper feed position inside the apparatus body 1a using a pulling force of a first coil spring 529 that acts on the engagement member 528 with the engagement member 528 engaging with the engagement pin 527 of the paper feed tray 51. The pull-in device 520c reduces an operation force applied when the user mounts the paper feed tray 51 to the apparatus body 1a. The pull-in device 520c is an abutment unit that abuts against the paper feed tray 51 when mounting the paper feed tray 51 to the apparatus body 1a. The pull-in device 520c is provided to reduce an operation force when mounting the paper feed tray 51, and does not correspond to the different abutment unit.

As illustrated in FIG. 4, a curved guide member 526 as an example of a guide member is disposed on the apparatus body 1a. The guide member 526 guides the recording paper 5 fed from the paper feed tray 51 by the nudger roller 52, the feed roller 53a, and the retard roller 53b upward along the vertical direction Z.

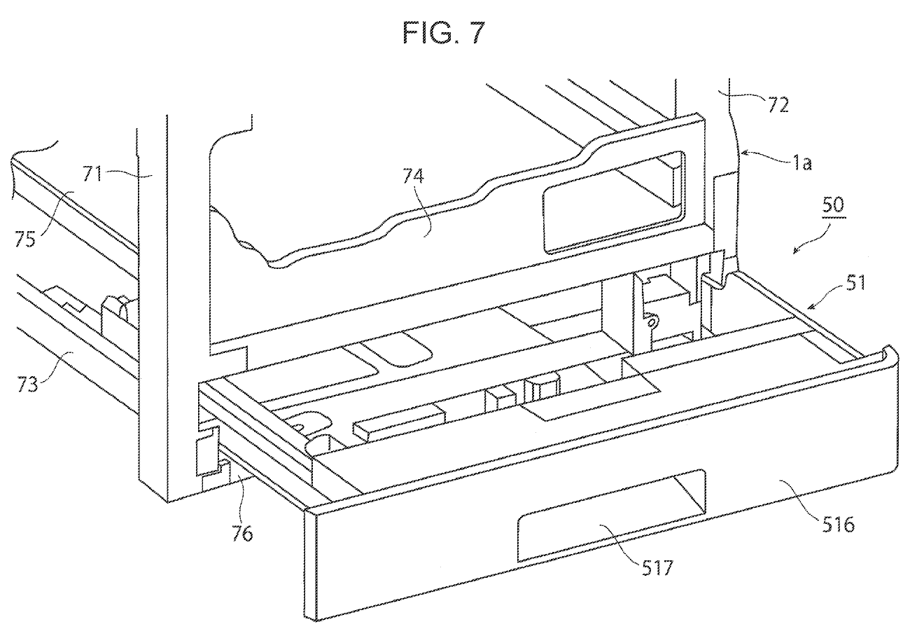

As illustrated in FIG. 7, the sheet storage device 50 is attached to a plurality of support column frames 71, 72, etc., that constitute the apparatus body 1a of the image forming apparatus 1. The support column frames 71, 72 are provided with a horizontal frame 73, a front surface plate 74, a partition plate 75, a separation plate 76, etc., by fastening, etc., using bolts (not illustrated). The horizontal frame 73 is disposed on the left and right sides of the apparatus body 1a along the horizontal direction X. The left and right side wall portions 512, 513 of the paper feed tray 51 are attached to the left and right horizontal frames 73 so as to be able to be pulled out and pushed in by guide rails and guide rollers (not illustrated). The imaging devices 10 (Y, M, C, K) for yellow (Y), magenta (M), cyan (C), and black (K) are attached to the front surface plate 74. The partition plate 75 partitions the imaging devices 10 (Y, M, C, K) and the sheet storage device 50. The separation plate 76 separates the plurality of paper feed trays 51 of the sheet storage device 50. The nudger roller 52, the feed roller 53a, the retard roller 53b, etc., of the sheet storage device 50 are attached to the horizontal frame 73 on the left side.

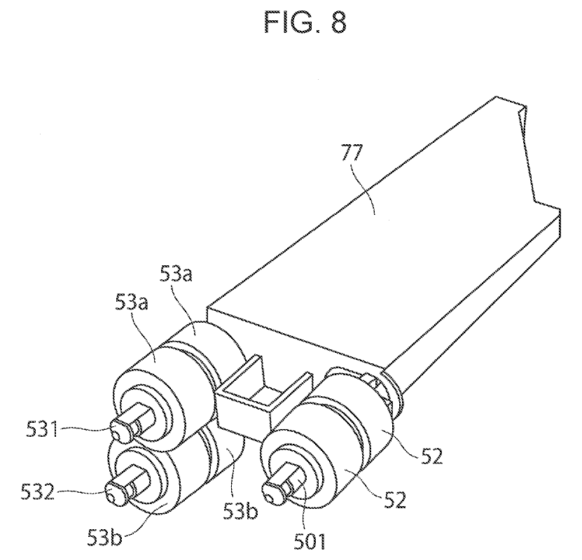

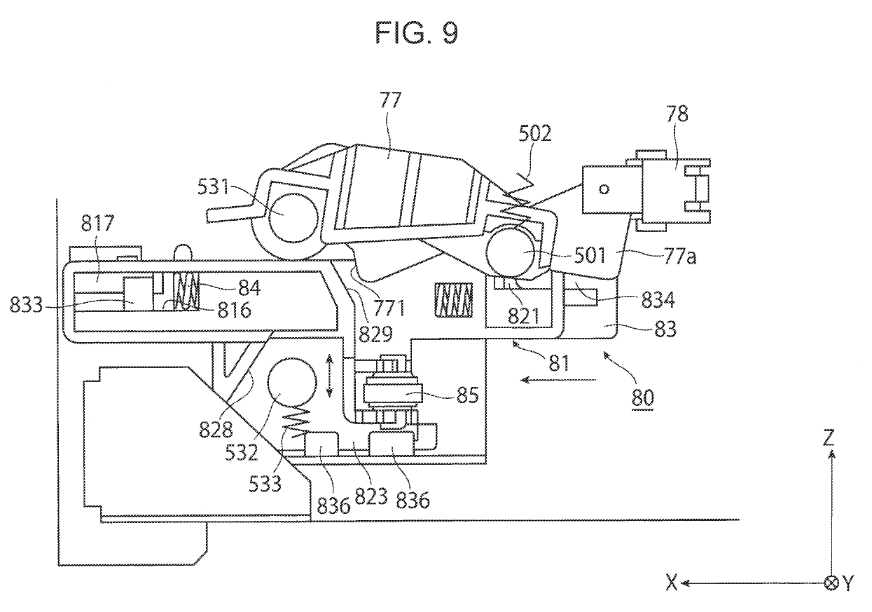

As illustrated in FIGS. 8 and 9, the feed roller 53a is rotatably attached with a rotary shaft 531 fixed in position to the apparatus body 1a. The nudger roller 52 is rotatably mounted to a support member 77 via a rotary shaft 501. The support member 77 is disposed so as to be swingable about the rotary shaft 531 of the feed roller 53a and bias the nudger roller 52 downward using a second coil spring 502. The position of the nudger roller 52 is detected by a position sensor 78 of the apparatus body 1a via an actuator 77a provided on the support member 77. The nudger roller 52 is driven by a driving force transmitted from the rotary shaft 531 of the feed roller 53a. As illustrated in FIG. 9, the retard roller 53b is attached to the support member 77 or the apparatus body 1a such that a rotary shaft 532 is movable closer to and away from the feed roller 53a and is biased by a third coil spring 533 into press contact with the feed roller 53a. The retard roller 53b is driven via the rotary shaft 531 of the feed roller 53a or by a drive source (not illustrated).

As illustrated in FIG. 1, the recording paper 5 fed from the sheet storage device 50 and guided upward along the vertical direction Z by the guide member 526 is transported to the second transfer position via the paper feeding transport path 56 constituted by the one or more paper transport roller pairs 54, 55, the transport guide (not illustrated), etc.

### Configuration of Press-contact Unit of Sheet Storage Device

The sheet storage device according to the first exemplary embodiment includes a press-contact unit that abuts against the sheet storage body mounted to the apparatus body to move one of transport rollers of the transport roller pair from a press-contact cancellation position (separation position) to a press-contact position.

In addition, the press-contact unit abuts against the sheet storage body earlier than a different abutment unit that abuts against the sheet storage body when mounting the sheet storage body to the apparatus body.

Further, the press-contact unit includes a moving member provided so as to be movable in a direction intersecting a mounting direction of the sheet storage body, the moving member abutting against the sheet storage body to move the one of the transport rollers of the transport roller pair from the separation position to the press-contact position.

That is, as illustrated in FIG. 5, the sheet storage device 50 according to the first exemplary embodiment includes a press-contact mechanism 80 as an example of the press-contact unit. The press-contact mechanism 80 is disposed at an end portion of the apparatus body 1a on the back surface side and at an end portion on the downstream side along the paper feed direction. The press-contact mechanism 80 brings the nudger roller 52 into press contact with the uppermost sheet of the recording paper 5, among the sheets of the recording paper 5 stored in the paper feed tray 51, along with operation to mount the paper feed tray 51 to the apparatus body 1a. Along with that, the press-contact mechanism 80 moves the retard roller 53b, as one transport roller of the feed roller 53a and the retard roller 53b, from the press-contact cancellation position (separation position) to the press-contact position at which the retard roller 53b is in press contact with the feed roller 53a.

On the other hand, the press-contact mechanism 80 moves the nudger roller 52 upward away from the uppermost sheet of the recording paper 5 in the paper feed tray 51 along with operation to extract the paper feed tray 51 from the apparatus body 1a. Along with that, the press-contact mechanism 80 moves the retard roller 53b from the press-contact position at which the retard roller 53b is in press contact with the feed roller 53a to the press-contact cancellation position at which the retard roller 53b is away from the feed roller 53a.

The following malfunction occurs in the press-contact mechanism 80 if operation to move the retard roller 53b to the press-contact cancellation position is delayed when pulling the paper feed tray 51 out of the apparatus body 1a. That is, when operation to move the retard roller 53b to the press-contact cancellation position is delayed, the distal end of the recording paper 5 is kept nipped by the feed roller 53a and the retard roller 53b in the middle of operation to extract the paper feed tray 51 from the apparatus body 1a. Then, the rear end of the recording paper 5 is pulled out of the apparatus body 1a together with the paper feed tray 51 with the distal end of the recording paper 5 kept nipped by the feed roller 53a and the feed roller 53b. As a result, the distal end portion of the recording paper 5 nipped by the feed roller 53a and the retard roller 53b is ripped off to remain inside the apparatus body 1a as so-called "residual paper".

Therefore, the press-contact mechanism 80 is configured to cancel nipping between the feed roller 53a and the retard roller 53b in the initial period of pull-out operation to pull the paper feed tray 51 out of the apparatus body 1a.

Specifically, as illustrated in FIG. 9, a slide lever 81 as an example of a moving member that constitutes the press-contact mechanism 80 is provided inside the apparatus body 1a at an end portion on the downstream side along the paper feed direction of the recording paper 5 and at an end portion of the paper feed tray 51 on the back surface side along the depth direction Y. The slide lever 81 is held by a holding member 83 so as to be movable along the horizontal direction X intersecting the depth direction Y as an attaching-detaching direction of the paper feed tray 51.

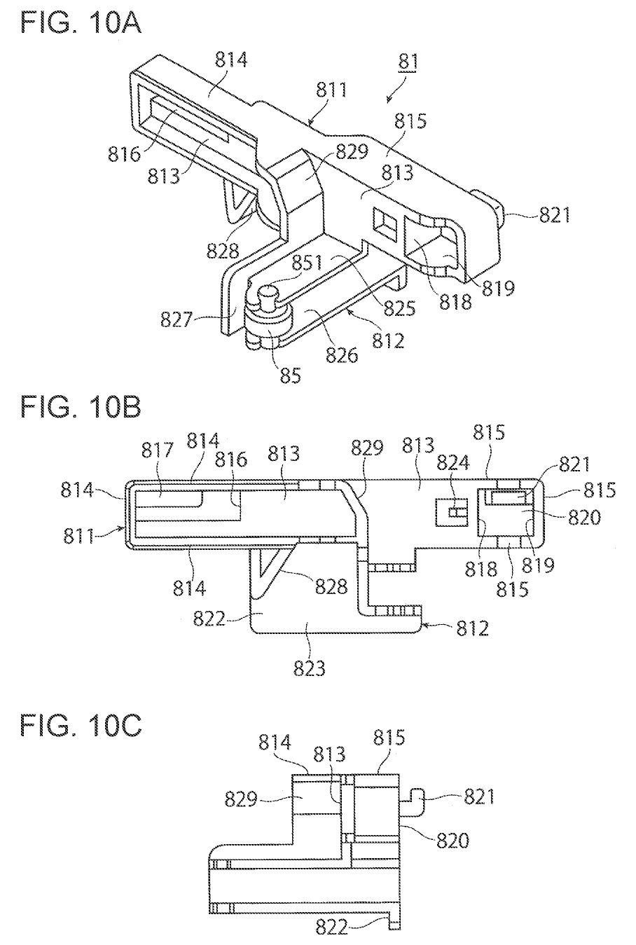

As illustrated in FIGS. 10A to 10C, the slide lever 81 roughly integrally includes a sliding portion 811 and an abutment portion 812. The sliding portion 811 of the slide lever 81 is formed as a frame body substantially in the shape of a long and thin rectangular parallelepiped along the horizontal direction X intersecting the attaching-detaching direction of the paper feed tray 51. Meanwhile, the abutment portion 812 of the slide lever 81 is provided so as to project toward the front surface side along the depth direction Y as the attaching-detaching direction of the paper feed tray 51 from the lower end portion of the sliding portion 811 at an intermediate position along the longitudinal direction.

More specifically, as illustrated in FIGS. 10A to 10C, the slide lever 81 includes a first front surface wall 813 formed in the shape of a long and thin rectangle along the longitudinal direction of the sliding portion 811. A region of the first front surface wall 813 on the left side with respect to the center along the longitudinal direction is surrounded by a first outer frame 814 provided on the front side of first front surface wall 813 on three sides including both the upper and lower end portions and the left end portion. Meanwhile, a region of the first front surface wall 813 on the right side with respect to the center along the longitudinal direction is surrounded by a second outer frame 815 provided on the back surface side of the first front surface wall 813 on three sides including both the upper and lower end portions and the right end portion. As illustrated in FIG. 10B, a first opening 816 substantially in an L-shape in front view surrounded by the first outer frame 814 is provided at the left end portion of the first front surface wall 813. A first guide portion 817 in the shape of a long and thin rectangle formed by leaving a part of the first front surface wall 813 is provided on the upper left side of the first opening 816.

On the other hand, a second opening 819 in a rectangular shape in front view surrounded by the second outer frame 815 and a partition wall 818 is provided at the right end portion of the first front surface wall 813. An end surface of the second opening 819 on the back surface side is closed by a back surface wall 820 except for a part of the second opening 819 at the upper end. As illustrated in FIG. 10C as a right side view, the back surface wall 820 is provided with a second guide portion 821 substantially in an L-shape in side view that projects toward the back surface side.

The slide lever 81 also includes a second front surface wall 822 disposed below the center of the sliding portion 811 along the longitudinal direction and on the back surface side of the abutment portion 812. As illustrated in FIG. 10C, the second front surface wall 822 is disposed at an end portion on the back surface side with respect to the first front surface wall 813. The lower end edge of the second front surface wall 822 constitutes a third guide portion 823 guided by the holding member 83.

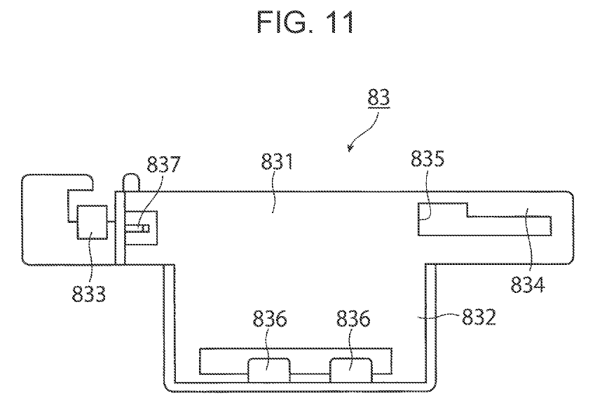

The slide lever 81 is held by the holding member 83 disposed on the back surface side so as to be movable along the horizontal direction X. As illustrated in FIG. 11, the holding member 83 is formed in substantially the same shape as the front surface shape of the slide lever 81. The holding member 83 includes a first holding portion 831 in the shape of a long and thin rectangle corresponding to the sliding portion 811 of the slide lever 81, and a second holding portion 832 that extends downward from the center of the first holding portion 831 along the longitudinal direction. The first holding portion 831 is provided with a fourth guide portion 833 at the left end portion along the longitudinal direction, the fourth guide portion 833 relatively guiding the first guide portion 817 of the slide lever 81. The fourth guide portion 833 is formed in the same shape as the second guide portion 821 of the slide lever 81. That is, the fourth guide portion 833 of the holding member 83 is formed so as to project substantially in an L-shape in side view toward the front surface side of the first holding portion 831. As illustrated in FIG. 9, the fourth guide portion 833 of the holding member 83 is inserted via the first opening 816 of the slide lever 81 to movably hold the first guide portion 817 of the slide lever 81.

In addition, the first holding portion 831 of the holding member 83 is provided with a fifth guide portion 834 at the right end portion along the longitudinal direction, the fifth guide portion 834 relatively guiding the second guide portion 821 of the slide lever 81. The fifth guide portion 834 is formed in the same shape as the first guide portion 817 of the slide lever 81. The fifth guide portion 834 is provided by providing a second opening 835 that opens substantially in an L-shape in front view at the right end portion of the first holding portion 831 to leave the fifth guide portion 834 in the shape of a long and thin rectangle. The fifth guide portion 834 is held so as to be movable along the horizontal direction X in the state of being fitted with the second guide portion 821 of the slide lever 81.

Further, the second holding portion 832 of the holding member 83 is provided with two sixth guide portions 836 at the lower end portion, the sixth guide portions 836 relatively guiding the third guide portion 823 of the slide lever 81. The sixth guide portions 836 are formed in the same shape as the second guide portion 821 of the slide lever 81. The sixth guide portions 836 are provided at the lower end portion of the second holding portion 832 so as to project substantially in an L-shape in side view toward the front surface side. The sixth guide portions 836 hold the third guide portion 823 of the slide lever 81 so as to be movable along the horizontal direction X.

The slide lever 81 is biased by a fourth coil spring 84 as an example of a biasing member that is a compression spring built in the sliding portion 811 so as to project along the rightward direction in the drawing with respect to the holding member 83. The slide lever 81 is stopped when the second guide portion 821 abuts against an end portion of the second opening 835 of the holding member 83. As illustrated in FIG. 10B, one end of the fourth coil spring 84 is retained by a first retention portion 824 provided on the inside surface of the partition wall 818 of the slide lever 81. As illustrated in FIG. 11, the other end of the fourth coil spring 84 is retained by a second retention portion 837 provided close to the left end portion of the holding member 83.

As illustrated in FIGS. 10A to 10C, the abutment portion 812 of the slide lever 81 includes first and second horizontal plate portions 825, 826 and a vertical plate portion 827. The first and second horizontal plate portions 825, 826 are disposed in parallel with each other so as to project toward the front side along the depth direction Y as the attaching-detaching direction of the paper feed tray 51 from the center of the first front surface wall 813 and the second front surface wall 822. The vertical plate portion 827 couples the first and second horizontal plate portions 825, 826 to each other along the vertical direction Z at one end portion (left end portion in the drawing) along the width direction. A sliding roller 85 is rotatably mounted at an end portion of the first and second horizontal plate portions 825, 826 on the front side along the depth direction Y as the attaching-detaching direction of the paper feed tray 51. The sliding roller 85 constitutes an abutment portion that directly abuts against the paper feed tray 51. The sliding roller 85 rotates about a rotary shaft 851 along the vertical direction. As discussed later, the sliding roller 85 pushes and moves the slide lever 81 leftward in the drawing by abutting against an abutted portion 86 of the paper feed tray 51 when mounting the paper feed tray 51.

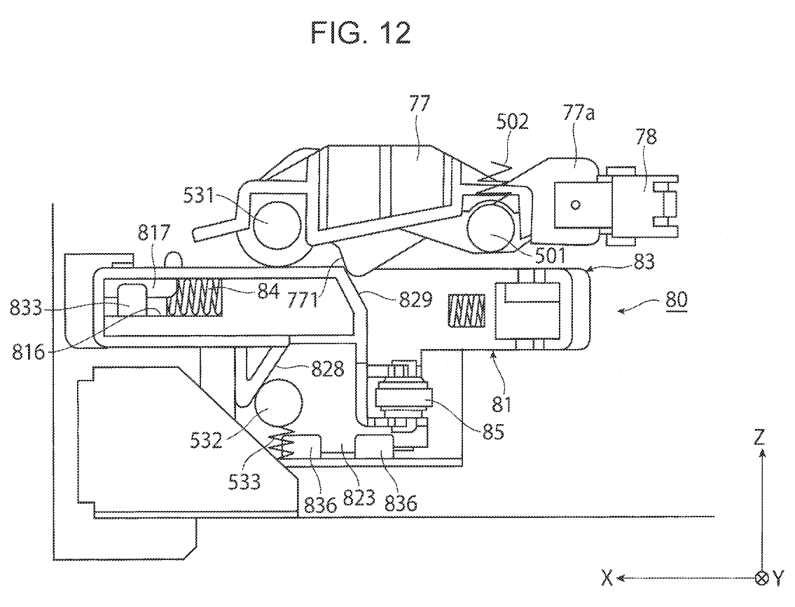

Further, as illustrated in FIGS. 10A to 10C, the slide lever 81 includes a first actuation portion 828 that operates to push down the rotary shaft 532 of the retard roller 53b. The first actuation portion 828 is a projecting portion substantially in the shape of a right triangle directed downward in front view. As illustrated in FIG. 12, when the paper feed tray 51 is pulled out, the slide lever 81 moves rightward in the drawing. Then, the first actuation portion 828 of the slide lever 81 abuts against the rotary shaft 532 of the retard roller 53b. Then, the first actuation portion 828 pushes down the rotary shaft 532 of the retard roller 53b to move the retard roller 53b away from the feed roller 53a.

In addition, the slide lever 81 includes a second actuation portion 829 that operates to push up the nudger roller 52. As illustrated in FIG. 10A, the second actuation portion 829 is constituted of a surface inclined downward toward the right and provided so as to project toward the front surface from the center of the first front surface wall 813 along the longitudinal direction. On the other hand, the support member 77 includes a push-up portion 771 that abuts against the second actuation portion 829 of the slide lever 81 to push up the support member 77. As illustrated in FIG. 12, the support member 77 rotates counterclockwise to move the nudger roller 52 away from the uppermost sheet of the recording paper 5 in the paper feed tray 51.

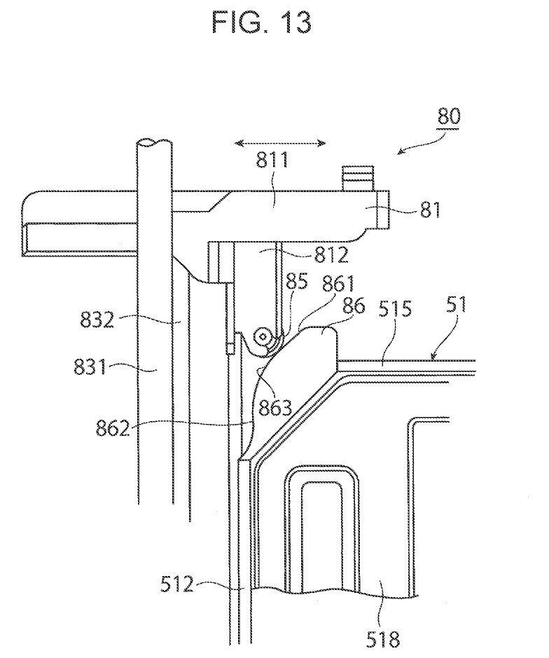

On the other hand, as illustrated in FIG. 13, the paper feed tray 51 includes an abutted portion 86 at an end portion on the deeper side along the attaching-detaching direction of the paper feed tray 51 and at an end portion on the downstream side along the paper feed direction of the recording paper 5. FIG. 13 is a perspective view of a portion of the paper feed tray 51 as seen from obliquely above. The abutted portion 86 is provided in the shape of a column that stands upright along the vertical direction Z at a corner portion at which the left side wall portion 512 and the rear wall portion 515 of the paper feed tray 51 intersect each other. The abutted portion 86 of the paper feed tray 51 abuts against the sliding roller 85 of the slide lever 81 on the apparatus body 1a side. In the abutted portion 86 of the paper feed tray 51, a start end portion at which abutment with the sliding roller 85 starts and a finish end portion at which abutment with the sliding roller 85 finishes are formed in a planar shape as first and second planar portions 861, 862, respectively. In the abutted portion 86 of the paper feed tray 51, in addition, an intermediate portion located between the first planar portion 861 and the second planar portion 862 is formed as a curved surface portion 863 in an arcuate shape in cross section. The boundary between the first planar portion 861 and the curved surface portion 863 serves as a separation start point at which the retard roller 53b separates from the feed roller 53a when the paper feed tray 51 is pulled out of the inside of the apparatus body 1a by a distance determined in advance.

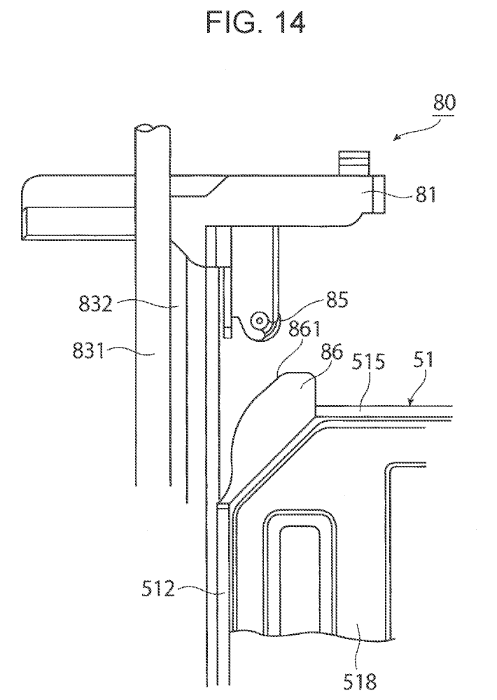

More specifically, when the paper feed tray 51 is pushed into the apparatus body 1a to be mounted, as illustrated in FIG. 14, the sliding roller 85 on the apparatus body 1a side abuts against the right end portion of the first planar portion 861 of the paper feed tray 51. At this time, as illustrated in FIG. 12, the slide lever 81 of the apparatus body 1a has been moved to an end portion on the right side in the drawing by the biasing force of the fourth coil spring 84 and stopped. In that event, the rotary shaft 532 of the retard roller 53b has been pushed down by the first actuation portion 828 of the slide lever 81, and the retard roller 53b has been separated from the feed roller 53a. In addition, the support member 77 has been pushed up by the second actuation portion 829 of the slide lever 81, and the nudger roller 52 has been located away above the recording paper 5 in the paper feed tray 51.

Next, when the paper feed tray 51 is pushed into the apparatus body 1a, as illustrated in FIG. 13, the sliding roller 85 on the apparatus body 1a side moves along the first planar portion 861 of the paper feed tray 51 to the boundary with the curved surface portion 863.

Then, the slide lever 81 of the apparatus body 1a is pushed by the abutted portion 86 of the paper feed tray 51 toward the state illustrated in FIG. 9 to move leftward in the drawing against the biasing force of the fourth coil spring 84.

When the slide lever 81 moves leftward in the drawing, operation of the first actuation portion 828 of the slide lever 81 to push down the rotary shaft 532 of the retard roller 53b is immediately canceled, and the retard roller 53b is brought into press contact with the feed roller 53a.

Conversely, when extracting the paper feed tray 51 from the apparatus body 1a, as illustrated in FIG. 13, the slide lever 81 moves rightward in the drawing, the rotary shaft 532 of the retard roller 53b is pushed down by the first actuation portion 828 of the slide lever 81, and the retard roller 53b is immediately separated from the feed roller 53a.

In the first exemplary embodiment, the sliding roller 85 that abuts against the abutted portion 86 of the paper feed tray 51 is disposed at the distal end of the abutment portion 812 provided on the slide lever 81 so as to project toward the front surface side. The position at which the sliding roller 85 of the slide lever 81 abuts against the abutted portion 86 of the paper feed tray 51 is set further on the front side than positions at which the paper feed tray 51 abuts against the driver 520a and the size detector 520b as the different abutment units. The sliding roller 85 of the slide lever 81 is the first member that the paper feed tray 51 first abuts against when the paper feed tray 51 is pushed into the apparatus body 1a.

The operation to cancel nipping between the feed roller 53a and the retard roller 53b and to push up the nudger roller 52 with the abutted portion 86 of the paper feed tray 51 abutting against the sliding roller 85 of the slide lever 81 is performed against the biasing force of the fourth coil spring 84 to move the slide lever 81. This operation force is greater than the operation forces of the driver 520a and the size detector 520b as the different abutment units that abut against the paper feed tray 51.

### Function of Sheet Storage Device

With the sheet storage device according to the first exemplary embodiment configured as described above, it is possible to reduce an operation force applied when mounting the sheet storage body to the apparatus body compared to when the press-contact unit abuts against the sheet storage body at the same time as the different press-contact unit, as follows.

That is, in the sheet storage device 50 according to the first exemplary embodiment, as illustrated in FIG. 7, the paper feed tray 51 is pulled out toward the front surface side of the apparatus body 1a by the user, such as when the paper feed tray 51 is replenished with the recording paper 5. Then, the paper feed tray 51 is replenished with the recording paper 5. After that, the paper feed tray 51 is mounted at the paper feed position in the apparatus body 1a when the user pushes the paper feed tray 51 into the apparatus body 1a via the grip portion 517 of the operation panel 516.

In that event, when the paper feed tray 51 is pushed into the apparatus body 1a to a certain extent, as illustrated in FIGS. 13 and 14, the paper feed tray 51 abuts against the sliding roller 85 of the slide lever 81 provided in the apparatus body 1a. Then, the sliding roller 85 of the slide lever 81 abuts against the abutted portion 86 of the paper feed tray 51, and moves downstream along the paper feed direction of the recording paper 5 as the horizontal direction X intersecting the mounting direction of the paper feed tray 51.

When the slide lever 81 moves downstream along the paper feed direction of the recording paper 5 as the horizontal direction X intersecting the mounting direction of the paper feed tray 51 in this manner, as illustrated in FIG. 9, operation of the first actuation portion 828 of the slide lever 81 to push down the rotary shaft 532 of the retard roller 53b is immediately canceled. Then, the retard roller 53b is biased upward by the third coil spring 533 to be brought into press contact with the feed roller 53a.

At the same time, operation of the second actuation portion 829 of the slide lever 81 to push up the nudger roller 52 is canceled along with movement of the slide lever 81. The nudger roller 52 is biased downward by the second coil spring 502 to be brought into contact with the uppermost sheet of the recording paper 5, among the sheets of the recording paper 5 stored in the paper feed tray 51.

The operation to move the slide lever 81 during the operation to mount the paper feed tray 51 is executed earlier than the operation of the different abutment units such as the driver 520a and the size detector 520b to abut against the paper feed tray 51.

That is, when mounting the paper feed tray 51 to the apparatus body 1a, the paper feed tray 51 first abuts against the sliding roller 85 of the slide lever 81, and completes the operation to push up the retard roller 53b and the operation to push down the nudger roller 52 via the slide lever 81.

After that, the paper feed tray 51 abuts against the different abutment members such as the driver 520a and the size detector 520b, making it possible to transmit a driving force and detect the size of the recording paper 5 stored in the paper feed tray 51.

The paper feed tray 51 may first abut against the sliding roller 85 of the slide lever 81, and complete the operation to push up the retard roller 53b and the operation to push down the nudger roller 52 via the slide lever 81. The paper feed tray 51 may abut against the driver 520a and abut against the size detector 520b at the same time. As a matter of course, the paper feed tray 51 may be configured to abut against the size detector 520b earlier than the driver 520a.

In this manner, when mounting the paper feed tray 51 to the apparatus body 1a, the paper feed tray 51 first abuts against the sliding roller 85 of the slide lever 81 which operates only as a mechanism to cancel movement of the nudger roller 52 and the retard roller 53b which requires the greatest operation force. Thus, when mounting the paper feed tray 51 to the apparatus body 1a, the operation force first applied to push in the paper feed tray 51 may be only an operation force that is necessary to operate the mechanism to cancel movement of the nudger roller 52 and the retard roller 53b.

As a result, it is possible to reduce an operation force applied when mounting the paper feed tray 51 to the apparatus body 1a compared to when the press-contact mechanism 80 abuts against the paper feed tray 51 at the same time as the different abutment units.

While the present disclosure is applied to a full-color image forming apparatus in the above exemplary embodiment, the present disclosure is also similarly applicable to a monochrome image forming apparatus as a matter of course.

While an image former of an electrophotographic system is employed in the above exemplary embodiment, this is not limiting, and an image former of an inkjet recording system, etc., may also be employed as a matter of course.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### (Appendix)

(1)

A sheet storage device comprising:

a sheet storage body that stores sheets and that is capable of being pulled out of and pushed into an apparatus body;

a transport roller pair provided in the apparatus body to separate and transport the sheets stored in the sheet storage body, one sheet at a time; and

a press-contact unit that abuts against the sheet storage body mounted to the apparatus body to move one of transport rollers of the transport roller pair from a press-contact cancellation position to a press-contact position,

wherein the press-contact unit abuts against the sheet storage body earlier than a different abutment unit that abuts against the sheet storage body when mounting the sheet storage body to the apparatus body.

(2)

The sheet storage device according to (1),

wherein the press-contact unit includes a moving member provided so as to be movable in a direction intersecting a mounting direction of the sheet storage body, the moving member abutting against the sheet storage body to move the one of the transport rollers of the transport roller pair from a separation position to the press-contact position.

(3)

The sheet storage device according to (2),

wherein the moving member includes an abutment portion that projects toward a front side along the mounting direction of the sheet storage body to abut against the sheet storage body.

(4)

The sheet storage device according to (3),

wherein the abutment portion of the moving member is provided with a rotatable roller.

(5)

The sheet storage device according to (2),

wherein the moving member is biased by a biasing member to move the one of the transport rollers of the transport roller pair to the separation position.

(6)

The sheet storage device according to (1),

wherein an abutted portion of the sheet storage body to be in abutment with the press-contact unit includes a curved portion in a part thereof.

(7)

The sheet storage device according to (6),

wherein the abutted portion of the sheet storage body includes first and second planar portions at a start end at which abutment with the press-contact unit starts and a finish end at which abutment with the press-contact unit finishes, respectively.

(8)

The sheet storage device according to (1),

wherein the different abutment unit includes at least one of a detector that detects a size of the sheets stored in the sheet storage body or a drive transmission unit that transmits a driving force from the apparatus body to the sheet storage body.

(9)

An image forming apparatus comprising:

a sheet storage that stores sheets; and

an image former that forms an image on the sheets,

wherein the sheet storage device according to any one of (1) to (8) is used as the sheet storage.

What is claimed is:

1. A sheet storage device comprising:
a sheet storage body that stores sheets and that is capable of being pulled out of and pushed into an apparatus body;
a transport roller pair provided in the apparatus body to separate and transport the sheets stored in the sheet storage body, one sheet at a time; and
a press-contact unit that abuts against the sheet storage body mounted to the apparatus body to move one of transport rollers of the transport roller pair from a press-contact cancellation position to a press-contact position,
wherein the press-contact unit abuts against the sheet storage body earlier than a different abutment unit that abuts against the sheet storage body when mounting the sheet storage body to the apparatus body.

2. The sheet storage device according to claim 1,
wherein the press-contact unit includes a moving member provided so as to be movable in a direction intersecting a mounting direction of the sheet storage body, the moving member abutting against the sheet storage body to move the one of the transport rollers of the transport roller pair from a separation position to the press-contact position.

3. The sheet storage device according to claim 2,
wherein the moving member includes an abutment portion that projects toward a front side along the mounting direction of the sheet storage body to abut against the sheet storage body.

4. The sheet storage device according to claim 3,
wherein the abutment portion of the moving member is provided with a rotatable roller.

5. The sheet storage device according to claim 2,
wherein the moving member is biased by a biasing member to move the one of the transport rollers of the transport roller pair to the separation position.

6. The sheet storage device according to claim 1,
wherein an abutted portion of the sheet storage body to be in abutment with the press-contact unit includes a curved portion in a part thereof.

7. The sheet storage device according to claim 6,
wherein the abutted portion of the sheet storage body includes first and second planar portions at a start end at which abutment with the press-contact unit starts and a finish end at which abutment with the press-contact unit finishes, respectively.

8. The sheet storage device according to claim 1,
wherein the different abutment unit includes at least one of a detector that detects a size of the sheets stored in the sheet storage body or a drive transmission unit that transmits a driving force from the apparatus body to the sheet storage body.

9. An image forming apparatus comprising:
a sheet storage that stores sheets; and
an image former that forms an image on the sheets,
wherein the sheet storage device according to claim 1, is used as the sheet storage.

10. An image forming apparatus comprising:
a sheet storage that stores sheets; and
an image former that forms an image on the sheets,
wherein the sheet storage device according to claim 2, is used as the sheet storage.

11. An image forming apparatus comprising:
a sheet storage that stores sheets; and
an image former that forms an image on the sheets,
wherein the sheet storage device according to claim 3, is used as the sheet storage.

12. An image forming apparatus comprising:
a sheet storage that stores sheets; and
an image former that forms an image on the sheets,
wherein the sheet storage device according to claim 4, is used as the sheet storage.

13. An image forming apparatus comprising:
a sheet storage that stores sheets; and
an image former that forms an image on the sheets,
wherein the sheet storage device according to claim 5, is used as the sheet storage.

14. An image forming apparatus comprising:
a sheet storage that stores sheets; and
an image former that forms an image on the sheets,
wherein the sheet storage device according to claim 6, is used as the sheet storage.

15. An image forming apparatus comprising:
a sheet storage that stores sheets; and
an image former that forms an image on the sheets,
wherein the sheet storage device according to claim 7, is used as the sheet storage.

16. An image forming apparatus comprising:
a sheet storage that stores sheets; and
an image former that forms an image on the sheets,
wherein the sheet storage device according to claim 8, is used as the sheet storage.
